(19) United States
(12) Patent Application Publication
(10) Pub. No.: US 2009/0305669 A1
(43) Pub. Date: Dec. 10, 2009

(54) TRANSACTION METHOD BETWEEN TWO SERVERS INCLUDING A PRIOR VALIDATING STEP USING TWO MOBILE TELEPHONES

(75) Inventors: Loïc Eonnet, Levallois (FR); Yves Eonnet, Saint Nom la Breteche (FR)

Correspondence Address: WEINGARTEN, SCHURGIN, GAGNEBIN & LEBOVICI LLP, TEN POST OFFICE SQUARE, BOSTON, MA, 02109, US

(73) Assignee: TAGATTITUDE, Rocquencourt (FR)

(21) Appl. No.: 12/539,931

(22) Filed: Aug. 12, 2009

Related U.S. Application Data
(63) Continuation-in-part of application No. 12/224,472, filed on Nov. 12, 2008.

(30) Foreign Application Priority Data
Mar. 2, 2006 (FR) 0650724

(51) Int. Cl. H04M 3/16; H04M 11/00

(52) U.S. Cl. 455/410; 455/406

(57) ABSTRACT

Before effecting a transaction between two servers, this method sets up a communications channel in a wireless telecommunications network between each server and a mobile terminal. One of the servers sends a signal on its wireless communications channel. That signal is received by the mobile terminal in wireless communication with the server, emitted by the loudspeaker of that mobile terminal, picked up by the microphone of the other mobile terminal, and sent by wireless communication to the other server. If the received signal is validated by one or both of the two servers, the transaction is effected.

This application is a continuation-in-part of U.S. patent application Ser. No. 12/224,472 filed Nov. 12, 2008, entitled TRANSACTION METHOD BETWEEN TWO SERVERS INCLUDING A PRIOR VALIDATING STEP USING TWO MOBILE TELEPHONES; which was a §371 national stage of International Application PCT/FR2007/050863 filed Mar. 1, 2007; which claims benefit of FR 0650724, filed Mar. 2, 2006, the whole of which are each hereby incorporated herein by reference. Priority to each of these applications is herein claimed.

### BACKGROUND OF THE INVENTION

The field of the invention is that of transactions effected between two servers interconnected via a telecommunications network of any kind.

The invention applies in particular when the two servers are interconnected via the Internet.

In the present document, the term “transaction” is to be understood in the widest sense. It refers to an operation that must be effected between the two servers, subject to prior authorization of one or both servers.

For example, the term “transaction” covers a monetary transaction in which each of the two servers manages the account of a user and must obtain an authorization before effecting a transfer from one account to the other.

The term “transaction” also covers rerouting a telephone call managed by a telephone server to a second telephone server following explicit authorization of one or both of the servers, in particular for billing purposes.

The term “transaction” also covers recording a piece of information in a database, the recording being subject of an authorization of one or both of the servers.

The invention also applies if both servers are in fact one and the same. This situation arises, for example, when the same server manages the bank accounts of two users, the authorization required to effect a transfer between these two accounts being managed by the same server in this situation.

The invention relates more particularly to transactions involving two mobile users.

To understand the invention better, consider the example of a person who wishes to transfer funds from his account to the account of a person who is located nearby. In the current state of the art, it is necessary for the first person to contact the server managing their bank account, for example via the Internet, and then to instruct a transfer by entering the banking details of the beneficiary of the transfer.

This approach is fairly tiresome for mobile users, since it requires entering the banking details of the beneficiary, with all the attendant risks of mistakes.

### OBJECT AND SUMMARY OF THE INVENTION

A main object of the present invention is therefore to alleviate the above-mentioned drawbacks by proposing a method of effecting a transaction involving two mobile users.

To be more precise, the invention relates to a method of effecting a transaction between a first server and a second server in a first telecommunications network. The method comprises, before the step of effecting the transaction:

a step of setting up a first communications channel in a wireless telecommunications network between the first server and a first mobile terminal;

a step of setting up a second communications channel in the wireless communications network between the second server and a second mobile terminal;

a step of the first server sending a signal on the first wireless communications channel, which signal is received by the first mobile terminal and sent by the first mobile terminal to the second mobile terminal;

a step of the second mobile terminal picking up the signal and sending it to the second server on the second wireless communications channel;

a step of one or both of the two servers verifying the validity of the received signal; and,

where applicable, as a function of the result of said verification, the step of effecting the transaction.

Thus, in outline, a transaction can be effected between two servers of a telecommunications network if the signal generated by one of the servers travels round a loop that includes the second server, this loop using two mobile telecommunications channels each set up between one of the servers and a mobile terminal, the channels being separated by a gap between the two terminals.

For the signal to travel round this loop, it is clearly necessary for the two mobile terminals to be near each other and to be such that the signal sent by the first mobile is picked up by the second mobile under excellent conditions, failing which the signal would not be received by the second server under good conditions and the transaction would therefore be refused.

In an embodiment of the invention with a single server, the transaction can be effected if and only if the signal generated by this server is received correctly by the same single server after having traveled round the loop using the two mobile communication channels set up between the server and the two terminals, the channels being separated by a gap between the two terminals.

Thus it is placing close to each other two terminals typically belonging to two participants in a transaction that enables them to demonstrate their readiness to effect the transaction.

By means of the invention, it is no longer necessary for the persons involved in the transaction to be authenticated explicitly, the security layers of the GSM protocol effecting the authentication and making the transaction secure.

Accordingly, there is no longer any risk of mistakes when entering user details.

Moreover, the signal sent by one of the two servers can advantageously carry a very long code, in practice one that is inviolable, and in any event much longer than the codes used in a standard password-based authentication mechanism.

The method of the invention has the advantage that it requires neither dedicated hardware (card reader, etc.) nor additional software in the users' mobile terminals. Consequently, the first and second communications channels can be set up by different operators and the mobile terminals can be from different manufacturers.

In one preferred implementation, the mobile terminals are placed so that the signal is reproduced by a loudspeaker of the mobile terminal that received the signal from a server and picked up by a microphone of the other mobile terminal.

In this particular implementation, it is therefore necessary to position the terminals head-to-tail, with the loudspeaker of the first mobile terminal at a very short distance from the microphone of the second terminal, failing which background noise would degrade the signal, which would then be considered erroneous by the second server.

This very short distance prevents a malicious third party picking up the signal output by the first mobile terminal.

The invention also provides a server connected to a first telecommunications network and including:

means for setting up a communications channel in a wireless telecommunications network with a mobile terminal;

means for sending a signal on the wireless communications channel to a second server connected to the first telecommunications network; and

means for authorizing a transaction with the second server if and only if the signal has been validated by one or both of the servers.

In a correlated way, the invention is directed to a method that can be used by a first server to authorize a transaction with a second server in a first telecommunications network, including:

a step of setting up a communications channel in a wireless telecommunications network with a mobile terminal;

a step of sending a signal on the wireless communications channel to the second server; and

a step of authorizing the transaction if the signal is received by the second server and validated by one or both of the servers.

The invention also provides a server including:

means for setting up a first communications channel in a wireless telecommunications network with a first mobile terminal;

means for setting up a second communications channel in a wireless telecommunications network with a second mobile terminal;

means for sending a signal on the first wireless communications channel;

means for receiving the signal on the second wireless communications channel; and

means for authorizing a transaction if and only if the received signal has been validated by said server.

In a correlated way, the invention is directed to a method that can be used by a server to authorize a transaction, including:

a step of setting up a first communications channel in a wireless telecommunications network with a first mobile terminal;

a step of setting up a second communications channel in a wireless telecommunications network with a second mobile terminal;

a step of sending a signal on the first wireless communications channel to the second server;

a step of receiving the signal on the second wireless communications channel; and

a step of authorizing the transaction if and only if the received signal has been validated by said server.

In a preferred implementation, the various steps of the authorization process are determined by computer program instructions.

Consequently, the invention is also directed to a computer program on a data medium, which program can be executed in a server or more generally in a computer, the program including instructions adapted to execute steps of the above authorization method.

This program can use any programming language and take the form of source code, object code or a code that is intermediate between source code and object code, such as a partially-compiled form, or any other desirable form.

The invention is also directed to a computer-readable data medium containing instructions of the above computer program.

The data medium may be any entity of device able to store the program. For example, the medium can include storage means, such as a read only memory (ROM), for example a CD ROM or a microelectronic circuit ROM, or magnetic storage means, for example a floppy disk, or a hard disk.

Moreover, the data medium may be a transmissible medium such as an electrical or optical signal, which can be routed via an electrical or optical cable, by radio or by other means. The program of the invention may in particular be downloaded over an Internet-type network.

Alternatively, the data medium may be an integrated circuit into which the program is incorporated, the circuit being adapted to execute the method in question or to be used in its execution.

The invention is also directed to a use of the above method to effect a monetary transaction between an account of a first user and an account of a second user, the accounts being managed by the first and second servers, respectively, the transaction being effected if and only if both users have previously set up a communications channel in a wireless communications network between their respective mobile terminals and respective ones of the servers, which terminals are positioned relative to each other so that a signal sent by one of the servers can be routed to the other server and validated by one or both of the servers.

The invention is further directed to a use of the above method of rerouting a telephone connection set up between a first telephone server and a first mobile terminal in a wireless communications network to a telephone connection set up between a second telephone server and a second mobile terminal in the wireless communications network, rerouting being effected if and only if the terminals are positioned relative to each other so that a signal sent by one of the servers can be routed to the other server and validated by one or both of the servers.

This use has the advantage of enabling a call received by a user on a mobile terminal to be rerouted to the mobile terminal of another user located nearby.

Once this rerouting has been effected, the telephone call set up with the first user is cleared down so that the user can switch off the mobile terminal or use it for something else.

The invention is further directed to the use of the above method to record in a database managed by a server the identifiers of two terminals if and only if the terminals are positioned relative to each other so that a signal sent by the server to a first terminal can be received by the server from the second terminal and validated by the server.

In an embodiment of the invention, this database is utilized in a social network service to establish a relationship between the users of the first and second terminals.

### BRIEF DESCRIPTION OF THE DRAWINGS

Other features and advantages of the present invention emerge from the following description, which is given with reference to the appended drawings, which show one non-limiting implementation of the invention. In the figures:

FIG. 1 represents, in their environment, two servers effecting a transaction in accordance with the invention; and

FIG. 2 represents in the form of a flowchart the main steps of a preferred implementation of a method of the invention for effecting a transaction;

FIG. 3 represents another embodiment of the invention.

### DETAILED DESCRIPTION

### Detailed Description of a First Implementation

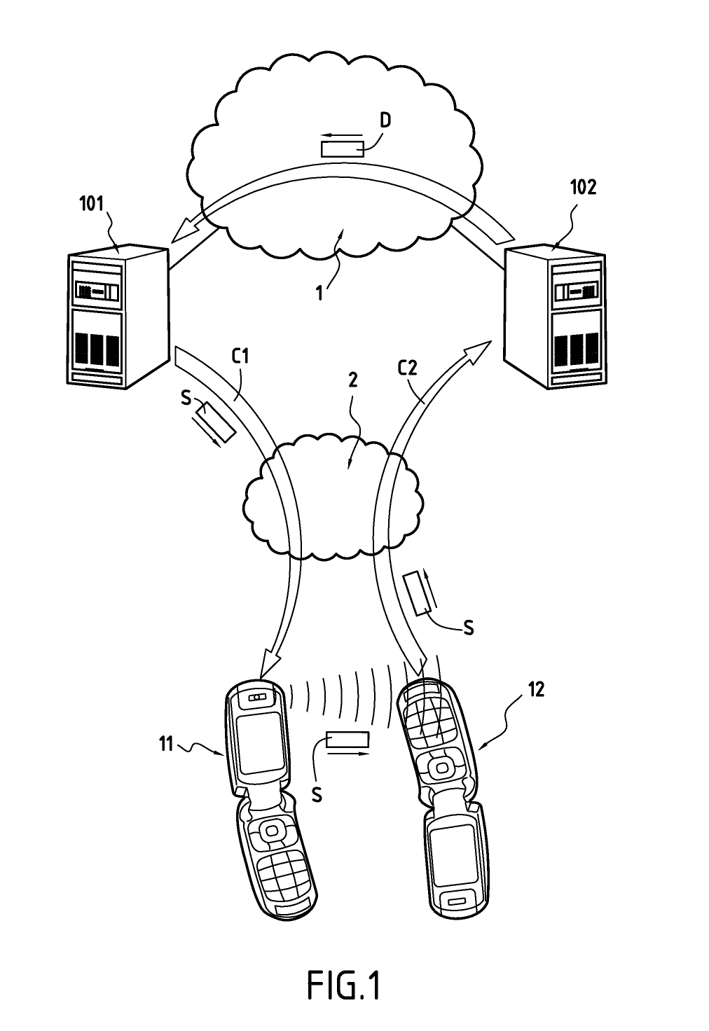

FIG. 1 represents two servers 101, 102 interconnected via a first telecommunications network 1.

In the example described here, the telecommunications network 1 is the Internet.

It is assumed in this example that the servers 101 and 102 manage the respective bank accounts of respective first and second users.

In this example, it is assumed that the second user wishes to transfer an amount to the account of the first user.

This operation is effected in a transaction between the two servers subject to explicit authorization by both users.

The scenario described here assumes that the two users are near each other, for example in the same room.

Each user has a mobile terminal, identified by the reference numbers 11 and 12 in FIG. 1.

It is assumed that, to effect the transaction, the first user, the one using the mobile terminal 11, calls a telephone number corresponding to the service and thereby sets up a first communications channel C1 in the wireless telecommunications network 2 with the first server 101.

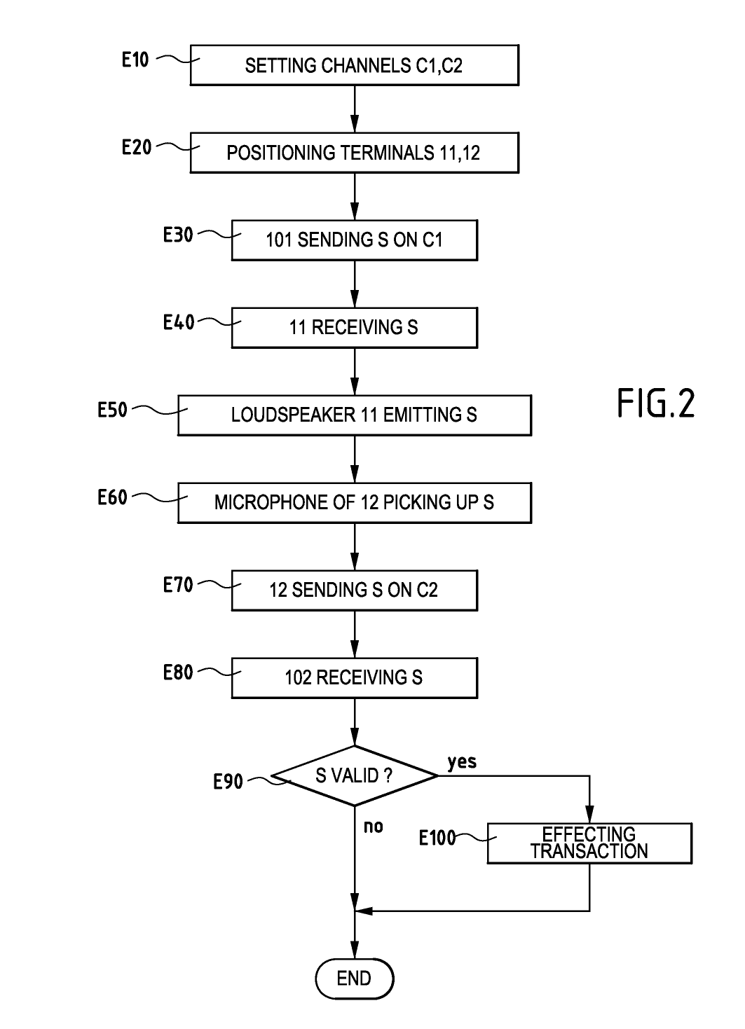

Setting up this first channel is part of the step E10 of a method of the invention for effecting a transaction, a flowchart of which is shown in FIG. 2.

In the scenario described here, the first server 101 sends a voice message on the first communications channel C1 to the first user, prompting them to press a predetermined key on their mobile terminal 11 to confirm their choice of service.

The first user then presses this key on their terminal 11, which causes a dual tone multi-frequency (DTMF) code to be sent to the first server 101.

The first server 101 then sends a voice message prompting the first user to send via the first communications channel C1 the number of the terminal 102 of the second user, with whom they wish to effect a transaction.

In the scenario described here, the first user enters this number on the keypad of their terminal 11, which number is transmitted via the first communications channel C1 to the first server 101 in the form of a sequence of DTMF codes.

It is assumed in this example that the first server 101 includes a database from which it obtains, using this number, the address in the first telecommunications network of a second server 102 managing the account of the second user.

The first server 101 sends a message over the first telecommunications network 1 to the second server 102 to advise it that a transaction is to be effected between the two servers.

According to the invention, during the same step E10, the second server 102 sets up a second communications channel C2 in the wireless mobile telecommunications network 2 with these mobile terminal 12 of the second user.

The situation is then as follows:

a first wireless communications channel has been set up between the first terminal 11 and the first server 101;

an Internet connection has been set up between the first server 101 and the second server 102; and

a second wireless telecommunications channel C2 has been set up between the second server 102 and the mobile terminal 12 of the second user.

One of the two servers, for example the second server 102, then prompts the user of the mobile terminal 12 with which it has set up the wireless communications channel C1 to place the loudspeaker of their mobile terminal 11 close to the microphone of the other mobile terminal 12.

It is assumed that the terminals 11 and 12 are then positioned appropriately (step E20).

After a predetermined delay, the first server 101 sends a signal S in the first wireless communications channel C1 (step E30).

This signal S is received by the first mobile terminal 11 in a step E40 and reproduced by the loudspeaker of the terminal 11 (step E50).

Given that the microphone of the terminal 12 has been placed close to the loudspeaker of the terminal 11, the signal S is picked up by the second mobile terminal 12 during a step E60.

The signal S is then routed via the second wireless communications channel 2 to the second server 102.

The second server 102 receives the signal S during a step E80.

Of course, this signal S is clearly received by the second server 102 because the two mobile terminals have been placed close together, in a very specific arrangement enabling the microphone of the terminal 12 to pick up the signal S reproduced by the loudspeaker of the terminal 11.

During a step E90, one or both of the two servers 101, 102 verifies the validity of the received signal S.

In a preferred implementation, the signal received by the second server 102 is transmitted by the first network 1 to the first server 101, which is able to compare this signal with the signal S that it sent in the sending step E30 already described.

In a different implementation, the second server 102 itself verifies whether the signal S received during the step E80 is valid.

Be this as it may, if the signal S is validated by one or both servers 101, 102, the servers consider that the users of the mobile terminals 11, 12 have agreed to carry out the transaction.

Consequently, the servers 101, 102 carry out the transaction during a step E100.

In the example described here, this transaction takes the material form of the second server 102 sending the first server 101 data D representing the amount of the transaction.

### Detailed Description of a Second Implementation

A second implementation of the invention is described below, in which the server 101 manages the bank accounts of the first and second users.

It is assumed here that during the step E10 the user of the first terminal 11 has set up a first communications channel C1 with the server 101 and communicated via that channel the amount they wish to transfer to the account of a second user, for example by sending a sequence of DTMF codes corresponding to the amount of the transaction entered on the keypad of the first terminal 11.

In this scenario, the server 101 does not send a message prompting the user to communicate to it the number of the terminal 102 of the beneficiary of the transaction, but merely prompts the user of the first terminal 11 to place their terminal 11 close to the terminal 12 of the beneficiary of the transaction.

In this scenario, it is assumed that the user of the second terminal 12 has previously called the telephone number corresponding to this service and has therefore set up a second communications channel C2 with the same server 101. It is further assumed that the user of the second terminal 12 has sent the server 101 a DTMF code indicating that it wishes to receive a transfer to its account. On reception of such a request, the server 101 prompts the user of the second terminal 12 to place the terminal 12 close to the terminal 11 of the other party to the transaction.

With the terminals positioned head-to-tail (step E20), the signal S sent (step E30) on the first wireless communications channel C1 by the server 101 is received (step E80) by the same server 101 on the second communications channel C2 set up with the second terminal 12.

The server 101 is then able to verify (step E90) that the signal S received on the second communications channel corresponds to that sent (step E30) to the first terminal 11. The transaction is then validated (step E100).

In this scenario, the user of the first terminal 11 does not need to know the telephone number of the terminal 12 of the other party to the transaction, the server 101 being sufficient to authenticate both parties, for example from the numbers of the terminals 11 and 12 obtained while setting up the communications channels C1 and C2.

Detailed description of a Third Implementation

A third use of the method of the invention is described below.

It is assumed here that the user of the mobile terminal 11 is in telephone communication with a third party, the call being managed by the first server 101. It is further assumed that the wireless communications channel C1 between the server 101 and the mobile terminal 11 was set up during a step E10.

During the conversation, the user of the mobile terminal 11 decides to reroute the telephone call in progress to the mobile terminal 12 of a user located nearby.

In this scenario, the user of the mobile terminal 11 presses a predetermined sequence of keys corresponding to this service.

This key sequence is received in the form of a DTMF code sequence by the first server 101.

On reception of this predetermined key sequence, the first server 101, using the communications channel C1 set up with the first mobile terminal 11, requests that the mobile telephone number to which the call must be rerouted should be sent to it.

It is assumed in this example that the number of that mobile telephone is entered on their keypad by the user of the mobile terminal 11.

That number is then received by the first server 101 via the first wireless communications channel C1.

As the two users are near each other, it is highly probable that the first server 101 will be able to open a second wireless communications channel with the mobile terminal 12 of the second user.

It is assumed that this is true and that the first server 101 sets up this channel C2 during the same step E10 of the method of the invention.

As described above, the first server 101 then prompts the user of the second mobile terminal 12, for example, to place the mobile terminals 11 and 12 head-to-tail so that the loudspeaker of one is facing the microphone of the other.

The terminals 11 and 12 are positioned correctly during a step E20.

Then, during a step E30, the server 101 sends a signal S, for example to the first mobile terminal 11, which signal S is received (step E40) by the terminal 11, reproduced (step E50) by its loudspeaker, and picked up (step E60) by the microphone of the other mobile terminal 12.

This signal then reaches the first server 101 via the second mobile communications channel C2 (steps E70 and E80), which server is able to verify its validity (step E90).

If the signal S is valid, that indicates that the users of the mobile terminals 11 and 12 have agreed for the telephone call with the third party to be rerouted from the first mobile terminal 11 to the second mobile terminal 12.

The first server 101 therefore effects this rerouting during a step E100.

In both implementations described here, the signal S is reproduced by the loudspeaker of one terminal and picked by the microphone of the other terminal.

Alternatively, other ultra-short-range communication techniques can be used to convey the signal S, and in particular infrared or digital radio technologies, for example technologies conforming to the WiFi or Bluetooth standards.

### Detailed Description of a Fourth Implementation

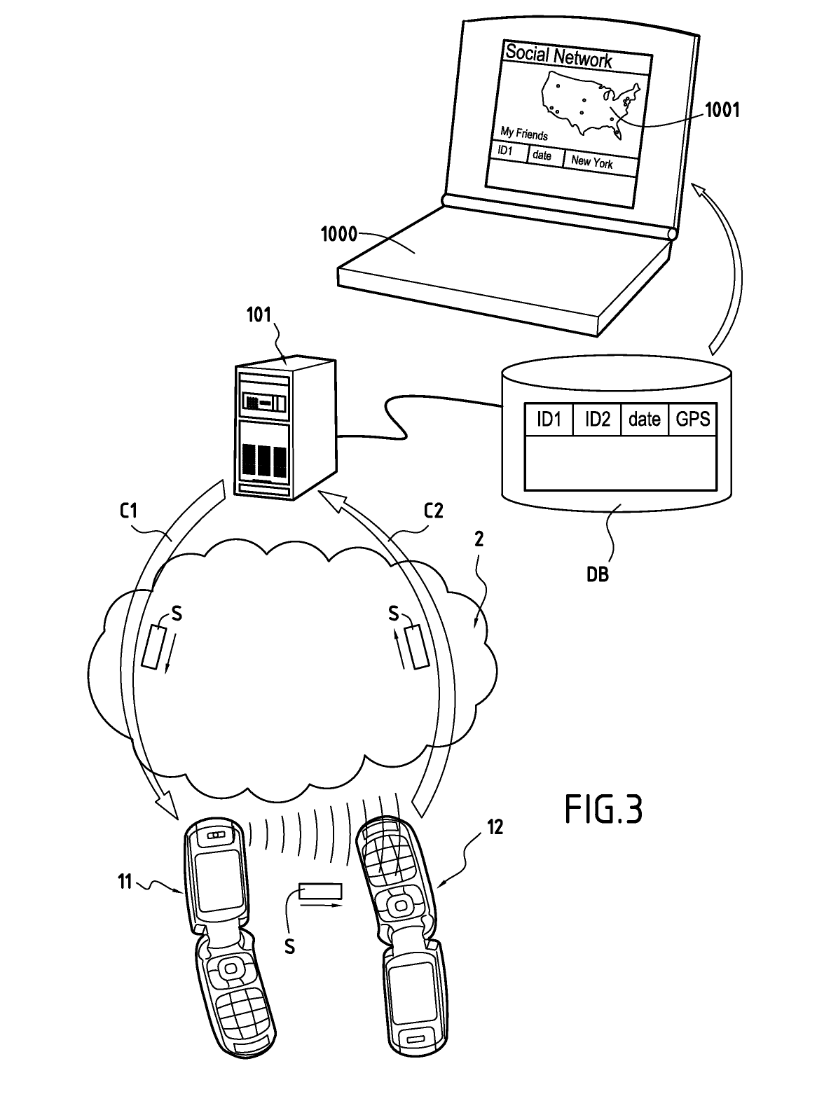

In reference to FIG. 3, a fourth implementation of the invention is described below, in which the server 101 manages a database DB.

It is assumed here that during the step E10 the user of the first terminal 11 has set up a first communications channel C1 with the server 101 and communicated via that channel he wishes to establish a relationship with the user of the second terminal 12.

In this scenario, the server 101 prompts the user of the first terminal 11 to place their terminal 11 close to the terminal 12.

In this scenario, it is assumed that the user of the second terminal 12 has previously called the telephone number corresponding to this service and has therefore set up a second communications channel C2 with the same server 101.

In this scenario, the server 101 prompts the user of the second terminal 12 to place the terminal 12 close to the terminal 11.

With the terminals positioned head-to-tail (step E20), the signal S sent (step E30) on the first wireless communications channel C1 by the server 101 is received (step E80) by the same server 101 on the second communications channel C2 set up with the second terminal 12.

The server 101 is then able to verify (step E90) that the signal S received on the second communications channel corresponds to that sent (step E30) to the first terminal 11.

The server 101 then records the identifiers ID1, ID2 of the terminals in the database DB (step E100).

In one embodiment, the date and time and the GPS localization of the terminals are also recorded in the database DB. In another embodiment, other pieces of information may be recorded in the database DB, and notably images, video images, a bid, and an amount for a payment. These pieces of information may be provided to the database DB by at least one of the two terminals or not.

This database DB can be used in a social network service.

For example, FIG. 3 represents the laptop 1000 of the user of terminal 11 accessing a social networking website.

According to an embodiment of this invention, this Website is fed with the content of the database DB and lists the relationships established in the real world.

In this example, it indicates the date and place (New-York) of the meeting recorded by server 101.

In this example, GPS localizations are also presented on a map 1001.

1. A method of effecting a transaction between a first server and a second server in a first telecommunications network, the method being characterized in that it comprises, before the step of effecting said transaction:
a step of setting up a first communications channel in a wireless telecommunications network between said first server and a first mobile terminal;
a step of setting up a second communications channel in said wireless communications network between said second server and a second mobile terminal;
a step of said first server sending a signal on said first wireless communications channel, which signal is received by said first mobile terminal and sent by the first mobile terminal to said second mobile terminal;
a step of said second mobile terminal picking up said signal and sending said signal on said second wireless communications channel, said signal being received by said second server;
a step of one or both of the two servers verifying the validity of said received signal; and,
where applicable, as a function of the result of said verification, said step of effecting the transaction.

2. A method according to claim 1, characterized in that said mobile terminals are placed so that said signal is reproduced by a loudspeaker of the mobile terminal that received said signal from a server and picked up by a microphone of the other mobile terminal.

3. A method of using the method according to claim 1, to effect a monetary transaction between an account of a first user and an account of a second user, said accounts being managed by said first and second servers, respectively, said transaction being effected if and only if each of said users has previously set up a communications channel in a wireless communications network between a mobile terminal and one of said servers, which terminals are positioned relative to each other so that a signal sent by one of said servers can be routed to the other server and validated by one or both of said servers.

4. A method of using the method according to claim 1, for rerouting a telephone connection set up between a first telephone server and a first mobile terminal in a wireless communications network to a telephone connection set up between a second telephone server and a second mobile terminal in said wireless communications network, said rerouting being effected if and only if said terminals are positioned relative to each other so that a signal sent by one of said servers can be routed to the other server and validated by one or both of said servers.

5. A server connected to a first telecommunications network and including:
means for setting up a communications channel in a wireless telecommunications network with a mobile terminal;
means for sending a signal on said wireless communications channel to a second server connected to said first telecommunications network; and
means for authorizing a transaction with said second server if and only if said signal has been validated by one or both of said servers.

6. A method that can be used by a first server to authorize a transaction with a second server in a first telecommunications network and comprising:
a step of setting up a communications channel in a wireless telecommunications network with a mobile terminal;
a step of sending a signal on said wireless communications channel to said second server; and
a step of authorizing said transaction if said signal has been received by said second server and validated by one or both of said servers.

7. A computer program including instructions for executing steps of the authorization method of claim 6 when said program is executed by a computer.

8. A computer-readable storage medium on which is stored a computer program comprising instructions for executing the steps of the authorization method according to claim 6.

9. A method that can be used by a server to authorize a transaction, including:
a step of setting up a first communications channel in a wireless telecommunications network with a first mobile terminal;
a step of setting up a second communications channel in a wireless telecommunications network with a second mobile terminal;
a step of sending a signal on the first wireless communications channel to the second server;
a step of receiving the signal on the second wireless communications channel; and
a step of authorizing the transaction if and only if the received signal has been validated by said server.

10. A method according to claim 9 including recording the identifiers of said first and second terminals in a database managed by said server.

11. A method according to claim 10 where said database is utilized in a social network service to establish a relationship between the users of the first and second terminals.

12. A server including:
means for setting up a first communications channel in a wireless telecommunications network with a first mobile terminal;
means for setting up a second communications channel in a wireless telecommunications network with a second mobile terminal;
means for sending a signal on the first wireless communications channel;
means for receiving the signal on the second wireless communications channel; and
means for authorizing a transaction if and only if the received signal has been validated by said server.

13. A method of using the method according to claim 2, to effect a monetary transaction between an account of a first user and an account of a second user, said accounts being managed by said first and second servers, respectively, said transaction being effected if and only if each of said users has previously set up a communications channel in a wireless communications network between a mobile terminal and one of said servers, which terminals are positioned relative to each other so that a signal sent by one of said servers can be routed to the other server and validated by one or both of said servers.

14. A method of using the method according to claim 2, for rerouting a telephone connection set up between a first telephone server and a first mobile terminal in a wireless communications network to a telephone connection set up between a second telephone server and a second mobile terminal in said wireless communications network, said rerouting being effected if and only if said terminals are positioned relative to each other so that a signal sent by one of said servers can be routed to the other server and validated by one or both of said servers.
